(19) United States
(12) Patent Application Publication
(10) Pub. No.: US 2007/0029238 A1
(43) Pub. Date: Feb. 8, 2007

(54) Mobile liquid treatment system and method

(76) Inventor: Sean R. Duby, Costa Mesa, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/498,950

(22) Filed: Aug. 3, 2006

Related U.S. Application Data
(60) Provisional application No. 60/705,334, filed on Aug. 4, 2005.

(51) Int. Cl. B01D 29/00

(52) U.S. Cl. 210/153

(57) ABSTRACT

A mobile liquid treatment apparatus, such as a filter assembly, includes a frame having a first end, a second end, and a platform extending between the first end and the second end. A filter is secured to the frame and is configured to separate a solid component from a liquid component of a solid liquid mixture. The mobile filter assembly includes at least a first deployment leg assembly secured to the first end of the frame and at least a second deployment leg assembly secured to the second end of the frame. A force generator is associated with each deployment leg assembly and is configured to apply a force to the first leg and the second leg to move the second leg relative to the first leg, such that the first and second deployment leg assemblies are capable of cooperating to raise the filter assembly to a desired height above a surface on which the filter assembly is supported. ISO lifting points may be provide to facilitate transport.

### CROSS-REFERENCE TO RELATED APPLICATIONS

This application is related to, and claims priority from, U.S. Provisional Patent Application No. 60/705,334, filed Aug. 4, 2005, the entirety of which is expressly incorporated by reference herein and made a part of the present specification.

### BACKGROUND OF THE INVENTION

1. Field of the Invention

The present invention relates generally to systems and methods for deploying equipment or other large objects. More specifically, the present invention relates to systems and methods for deploying a mobile liquid treatment assembly.

2. Description of the Related Art

It is often desirable for industrial equipment, such as large scale industrial filters, to be moved to a particular worksite for a limited amount of time before moving on to another worksite, as opposed to being permanently installed at a specific location. Presently, industrial filters for mobile applications are often integrated into a semi trailer so as to be movable by a semi truck. Such an arrangement has several significant disadvantages. For example, an industrial filter that is integrated into a semi truck trailer includes significant structural components that are only useful while the integrated filter/trailer is in motion, e.g., the axles, wheels and brakes. In addition, once the integrated filter/trailer is at the desired worksite, removing filter solids produced during a filter cycle is difficult due to the trailer structure beneath the filter. A conveyer must be used to remove solids from the filter, which ads to the total system cost.

### SUMMARY OF THE INVENTION

Accordingly, a need exists for a mobile industrial liquid treatment system that overcomes the disadvantages of the prior art. Preferred embodiments of the present system permit a mobile filter to be deployed quickly and are less expensive than the prior art constructions because transport specific components are not necessary. In addition, the preferred embodiments also enhance the removal of filter solids. Furthermore, the filter is separable from the trailer so that the trailer may be utilized only for transport of the filter and is not left sitting idle while the filter is in operation at the remote location. Thus, the trailer may be utilized to transport additional filters (or other objects) after transporting a first filter. In addition, the filter may be transported by alternative means, such as by train, plane or ship, for example. Although the present invention is described in the context of a preferred embodiment involving a filter, the present system and methods may also be used to transport other objects or equipment, as described herein.

A preferred embodiment is a mobile filter assembly including a frame having a first end, a second end, and a platform extending between the first end and the second end. A liquid treatment device, such as a filter, is secured to the frame and is configured to separate a solid component from a liquid component of a solid liquid mixture. The mobile filter assembly includes at least a first deployment leg assembly secured to the first end of the frame and at least a second deployment leg assembly secured to the second end of the frame. Each of the deployment leg assemblies includes a first leg and a second leg movable relative to one another. The first leg is securable to the frame and the second leg includes a surface contacting foot at a lower end. A force generator is associated with each deployment leg assembly and is configured to apply a force to the first leg and the second leg to move the second leg relative to the first leg, such that the first and second deployment leg assemblies are capable of cooperating to raise the filter assembly to a desired height above a surface on which the filter assembly is supported.

A preferred embodiment is a method of deploying a mobile filter including loading a filter onto a delivery vehicle at a first location, the filter supported by an integral frame. The frame includes a platform surrounding at least a portion of the filter. Moving the vehicle including the filter to a desired location remote from the first location. The method also includes utilizing a first deployment leg and a second deployment leg to raise respective first and second ends of the filter to a first height relative to a surface on which the filter is desired to be supported, such that the delivery vehicle may be removed from underneath the filter. The method includes continuing to raise the filter with the first and second deployment legs to a second height greater than the first height. The method further includes maintaining the filter at the second height and positioning a waste receptacle below the filter, which is configured to receive solid particulate cake discharged from the filter.

Yet another preferred embodiment is a mobile filter assembly including a frame having a first end, a second end, and a platform extending between a lower portion of the first end and a lower portion of the second end. Each of the first end and the second end has four corners cooperating to define a rectangular shape. A filter is secured to the frame and includes a plurality of filter plates configured to cooperate to form a filter chamber. The filter additionally includes a clamping mechanism configured to apply a squeezing force to the plurality of filter plates to seal the filter chamber. The filter is configured to separate a solid component from a liquid component of a solid liquid mixture. A mount located at each of the corners of the first and second ends are sized, shaped and located to correspond with an ISO standard for container mounts.

Another preferred embodiment is a method of deploying an object to a remote location including loading the object onto a delivery vehicle at a first location, moving the delivery vehicle including the object to a desired second location remote from the first location, and applying a force to first and second movable portions of at least a first deployment leg and a second deployment leg to raise respective first and second ends of the object to a first height relative to a surface on which the object is desired to be supported, such that the delivery vehicle may be removed from underneath the object. The method further includes continuing to raise the object with the first and second deployment legs to a second height greater than the first height, removing the force from the first and second portions of the deployment legs and maintaining the object at the second height.

### BRIEF DESCRIPTION OF THE DRAWINGS

These and other features, aspects and advantages of the present invention are described below with reference to drawings of preferred embodiments, which are intended to illustrate, but not to limit, the present invention. The drawings contain 33 figures.

FIG. 1 is a perspective view of a mobile filter assembly having certain features, aspects and advantages of the present invention. The filter assembly is supported on a transport trailer, which is coupled to a semi truck. The filter assembly includes a support structure including a platform and end portions. A pair of active deployment legs is configured to raise the filter assembly.

FIG. 2 illustrates the mobile filter assembly of FIG. 1 with passive deployment legs at each corner of the filter assembly deployed to support the filter assembly in an elevated orientation above the transport trailer.

FIG. 3 illustrates the mobile filter assembly raised to a further elevated orientation with the transport trailer removed from underneath the mobile filter assembly and a waste receptacle placed beneath the mobile filter assembly. A set of stairs are secured to a frame of the mobile filter assembly to permit access to the platform.

FIG. 4 is a side view of one corner of the mobile filter assembly of FIG. 1 illustrating a passive deployment leg in a stowed position.

FIG. 5 is a top view of the corner of the filter assembly shown in FIG. 4 with the passive deployment leg in a stowed position, an intermediate position and a deployed position.

FIG. 6 is a side view of a retention mechanism configured to retain an inner leg relative to an outer leg of the passive deployment leg.

FIG. 7 is a view of an end of the mobile filter assembly viewed from the center of the filter assembly and illustrating a centrally located active deployment leg.

FIG. 8 is a side view of the active deployment leg of FIG. 7 including a hydraulic pump and hydraulic cylinder configured to extend the active deployment leg.

FIG. 9 is a top view of the active deployment leg of FIG. 7.

FIG. 10 is a perspective view of the end of the mobile filter assembly shown in FIG. 7 with the active deployment leg in a deployed position.

FIG. 11 is a perspective view of a modification of the mobile filter assembly of FIGS. 1-10.

FIG. 12 is a perspective view of the mobile filter assembly of FIG. 11 including an active deployment leg secured to each corner of the filter assembly.

FIG. 13 is a perspective view of the mobile filter assembly of FIG. 11 with the deployment legs in an extended position.

FIG. 14 is a perspective view of the filter assembly of FIGS. 11-13 in a raised position in preparation for being loaded onto a transport trailer.

FIG. 15 is a perspective view of the filter assembly being loaded onto the transport trailer.

FIG. 16 is a perspective view of the filter with the deployment legs in a retracted position and the filter assembly supported by the transport trailer.

FIG. 17 is a perspective view of the filter assembly with the deployment legs in a stowed position.

FIG. 18 is a perspective view of the filter assembly supported on the transport trailer in preparation for removal from the transport trailer. The deployment legs are moved to a deployed position.

FIG. 19 is a perspective view of the filter assembly with the deployment legs in an extended position to raise the filter assembly from the transport trailer.

FIG. 20 is a perspective view of the filter assembly with the deployment legs in a further extended position to raise the filter assembly further off of the transport trailer.

FIG. 21 is a perspective view of the filter assembly in an elevated position with the transport trailer removed from underneath the filter assembly.

FIG. 22 is a perspective view of the filter assembly in an elevated position with a waste container positioned beneath the filter assembly.

FIG. 23a is a side view of the filter assembly supported on a transport trailer.

FIG. 23b is a rear view of the filter assembly as shown in FIG. 23a.

FIG. 24a is a side view of the filter assembly on the transport trailer with the deployment legs moved to a deployed position.

FIG. 24b is a rear view of the filter assembly as shown in FIG. 24a.

FIG. 25a is a side view of the filter assembly with the deployment legs in an extended position to raise the filter assembly off of the transport trailer.

FIG. 25b is a rear view of the filter assembly as shown in FIG. 25a.

FIG. 26a is a side view of the filter assembly further raised off of the transport trailer by the deployment legs relative to the position shown in FIG. 25.

FIG. 26b is a rear view of the filter assembly as shown in FIG. 26a.

FIG. 27a is a side view of the filter assembly in an elevated position with the transport trailer removed from beneath the filter assembly.

FIG. 27b is an end view of the filter assembly as shown in FIG. 27a.

FIG. 28a is a side view of the filter assembly in an elevated position with a waste container positioned beneath the filter assembly.

FIG. 28b is a rear view of the filter assembly as shown in FIG. 28a.

FIG. 29 is a perspective view of the filter assembly with the deployment legs removed.

FIG. 30 is a plan view of a hinge of the filter assembly configured to rotatably support the deployment legs.

FIG. 31 is a side view of a deployment leg removed from the filter assembly.

FIG. 32 is a cross-sectional view of the deployment leg of FIG. 31.

FIG. 33 is a perspective view of the deployment leg of FIG. 31.

### DETAILED DESCRIPTION OF THE PREFERRED EMBODIMENT

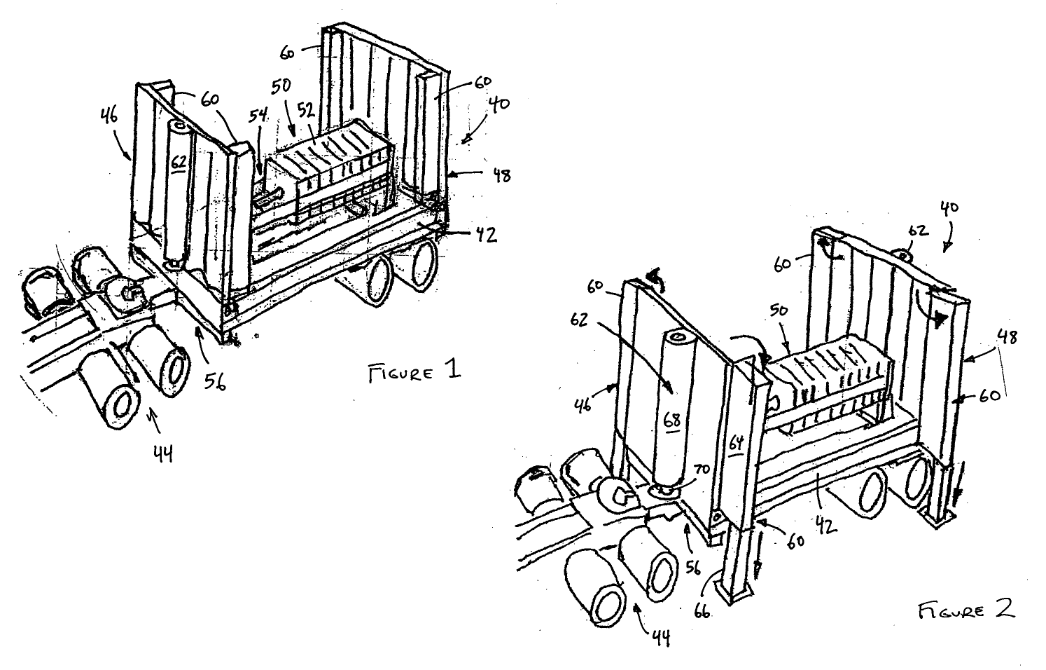

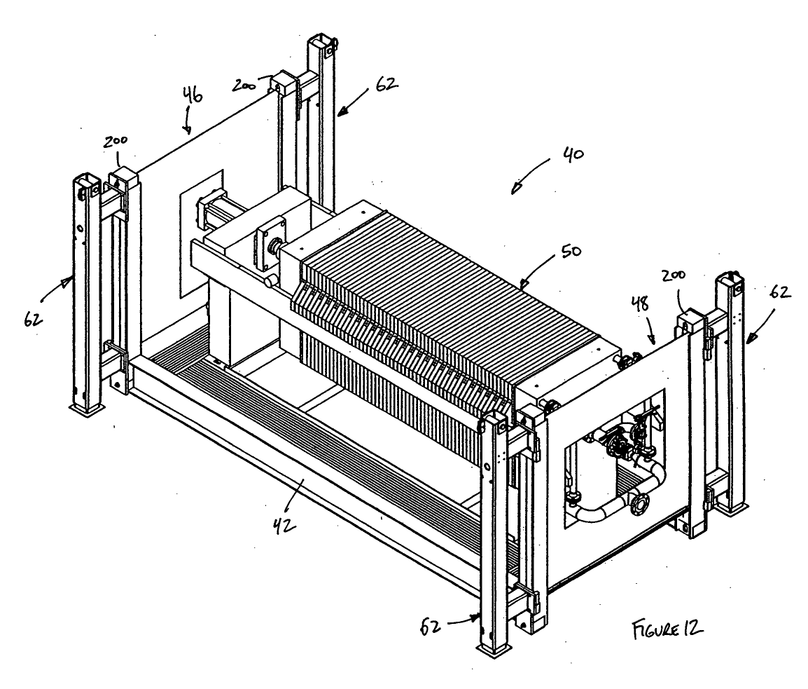

A preferred embodiment of the present mobile filter assembly is described with reference to FIGS. 1-10. The mobile filter assembly is generally referred to by the reference numeral 40. Preferably, the filter assembly 40 includes a platform 42, which extends the entire length of the filter assembly 40. The platform 42 may be of any suitable size, but preferably is configured to be transportable by a semi truck 44. Thus, preferably, the platform 42 (and filter assembly 40) are no larger than a standard semi trailer, and may be substantially smaller. However, in other arrangements configured for alternative types of transport, the overall dimensions of the filter assembly 40 may be modified.

The platform 42 includes a forward end portion 46 and a rearward end portion 48. In the illustrated arrangement, the forward end 46 and the rearward end 48 are in the form of support structures, or support walls, which extend upwardly from the platform 42. However, in other arrangements, the ends 46, 48 may not extend upwardly from the platform 42. Furthermore, the term “support walls” as used herein is a broad term than covers many structures suitable to support other components relative to the platform 42. Thus, it is not necessary that the walls be of a solid construction, as they may also be in the form of an open truss.

The platform 42 supports a filter 50, which preferably is configured to separate a solid component and a liquid component from a solid-liquid mixture, or slurry. The filter 50 may be of any suitable construction that is configured to be mobile. The platform 42 preferably surrounds at least a portion of the filter 50 and is configured to permit a person to access portions of the filter 50 for operation, maintenance or repair.

In the illustrated arrangement, the filter 50 is a filter press including a plurality of filter plates 52 which cooperate to define a filter cavity. The filter 50 includes a clamping mechanism 54 which is configured to apply a clamping force to the plurality of filter plates 52 to create a seal between the filter plates 52 and, thus, seal the filter chamber of the filter 50. As will be appreciated by one of skill in the art, the filter plates 52 are configured to separate from one another at the end of a filter cycle to permit collected solids (referred to as a filter cake) to be discharged from the filter 50. However, other suitable types of filters may be provided including various types of batch filters or continuous filters. In addition, it is not necessary that all of the filter components be included. That is, certain components necessary or desirable for operation of the filter 50 may be provided at the site at which the filter 50 will be used, such as hydraulic power, electrical power or a supply of water, for example but without limitation.

Preferably, the forward end 46 and rearward end 48 of the filter assembly 40 include supports configured to support the filter assembly with the platform 42 in an elevated position once a transport trailer 56 used to transport the filter assembly 40 is removed. Preferably, the supports include one or more deployment legs and, in the illustrated arrangement, include both passive deployment legs 60 and active deployment legs 62. Preferably, the passive deployment legs 60 are configured to be variable in height to support the filter assembly 40 in an elevated position such that the platform 42 is elevated above a surface on which the filter assembly 40 is supported.

The illustrated passive deployment legs 60 include a first leg portion 64 (outer or upper leg) and a second leg portion 66 (inner or lower leg) telescopically received within the first leg portion 64. The first leg portion 64 and the second leg portion 66 may be secured in one of a plurality of relative positions to define a desired height of the deployment leg 60. In addition, the construction of the legs 60 may be reversed such that the upper leg 64 is within the lower leg 66, if desired. Other suitable constructions may also be used.

The active deployment legs 62 also include a first leg portion 68 (upper or outer leg) and a second leg portion 70 (inner or lower leg) telescopically received within the first leg portion 68. The active deployment leg 62 is configured to produce a force tending to extend the first leg portion 68 and the second leg portion 70 relative to one another, such that the active deployment leg 62 may be used to lift the filter assembly 40. The active deployment leg 62 may use any suitable force generating mechanism, such as a hydraulic system, for example, as described in greater detail below. In addition, the construction of the legs 62 may be reversed such that the upper leg 68 is within the lower leg 70, if desired. Other suitable constructions may also be used.

In the illustrated arrangement, passive deployment legs 60 are positioned at each corner of the filter assembly 40. That is, each side of the forward end 46 and rearward end 48 include a passive deployment leg 60. Preferably, each of the forward end 46 and rearward end 48 include a single active deployment leg 62, which desirably is generally centered within the ends 46, 48. The active deployment legs 62 may be positioned or otherwise configured to contact the transport trailer 56 or the surface upon which the filter assembly 40 is supported in order to raise the filter assembly 40 to an elevated position. In addition, the active deployment legs 62 may be configured to contact any other suitable structure from which to move the filter assembly 40 to an elevated position, such as an intermediary support, for example.

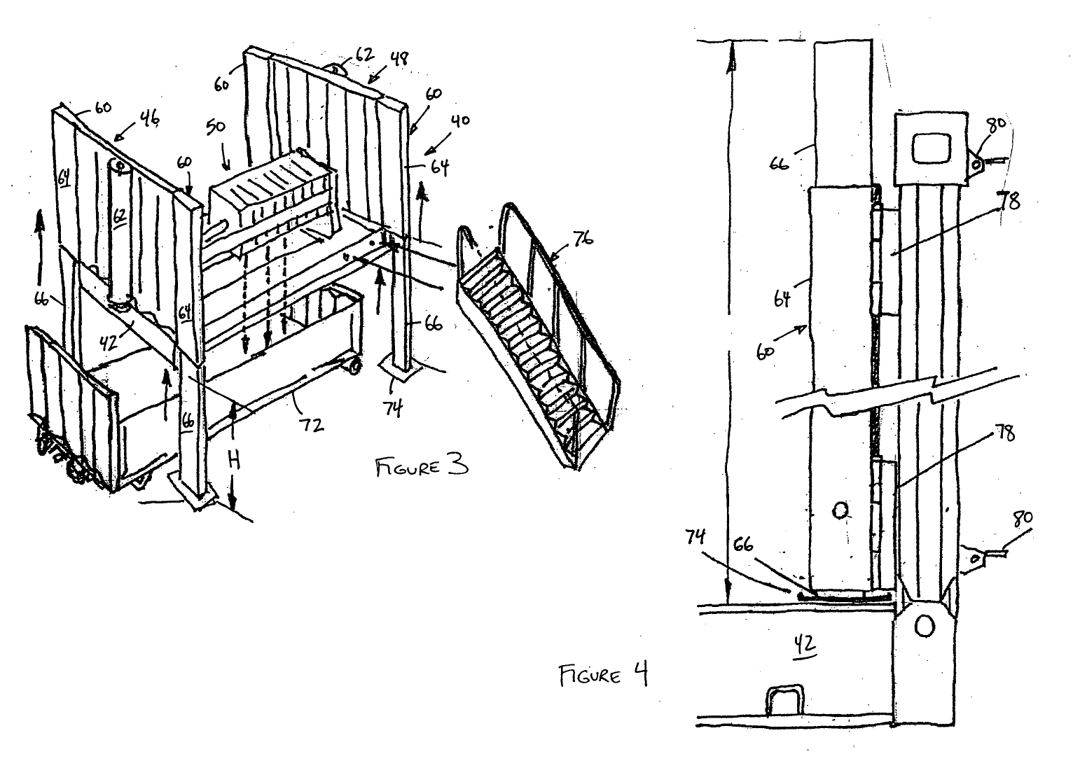

The passive deployment legs 60 are movable from a stowed position, as illustrated in FIG. 1, to a deployed position, as illustrated in FIG. 2. In the stowed position, the passive deployment legs 60 preferably are within a perimeter defined by the platform 42 and are rotatable outside the perimeter of the platform 42 in the deployed position.

Once the active deployment legs 62 have been utilized to raise the filter assembly 40 to a desired height H above a surface upon which the filter assembly 40 rests, the passive deployment legs 60 are utilized to maintain the filter assembly 40 in an elevated position. Desirably, the height H at which the platform 42 is elevated above the surface upon which the filter assembly 40 rests may vary. Preferably, the height H is sufficient to permit the transport trailer 56 to be removed from underneath the filter assembly 40. Preferably, the filter assembly 40 is capable of being raised to a height H that is sufficient to permit a waste container 72 to be positioned beneath the platform 42 in order to receive particulate cake discharged from the filter 50. Thus, the filter assembly 40 may be raised to an initial height H, which permits the trailer 56 to be removed, and subsequently raised to a secondary height, which permits the waste container 72 (or other desirable object) to be positioned beneath the filter assembly 40. In one arrangement, the height H is at least six feet.

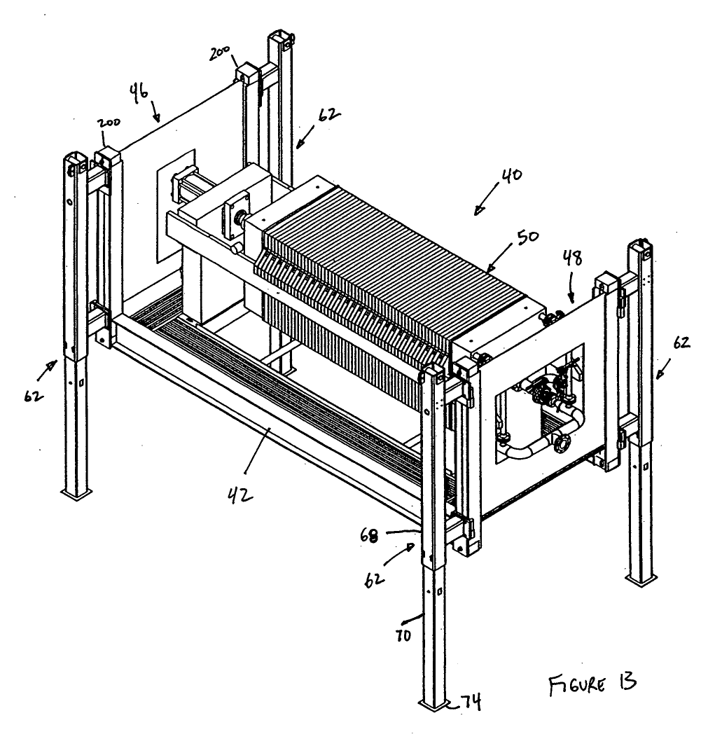

As illustrated in FIGS. 2 and 3, the second leg portions 66 of the passive deployment legs 60 may include feet 74 at the lower ends thereof that are configured to contact the surface upon which the filter assembly 40 rests. The feet 74 may be configured to inhibit the filter assembly 40 from sinking into the surface or sliding on the surface. Accordingly, the feet 74 may have an enlarged support surface area to inhibit sinking and may be textured or otherwise configured to improve the grip of the feet 74 on the surface upon which the filter assembly 40 rests. As illustrated in FIG. 10, the inner leg 70 of the active deployment leg 62 may include a support foot 74, similar to the support foot 74 of the passive deployment legs 60 described above.

Desirably, the filter assembly 40 includes a set of removable stairs 76 which are configured to be removably secured to the platform 42 or other suitable portion of the filter assembly 40. The stairs 76 may be bolted or otherwise secured to the platform 42 to permit access to the platform 42 from the surface upon which the filter assembly 40 is supported.

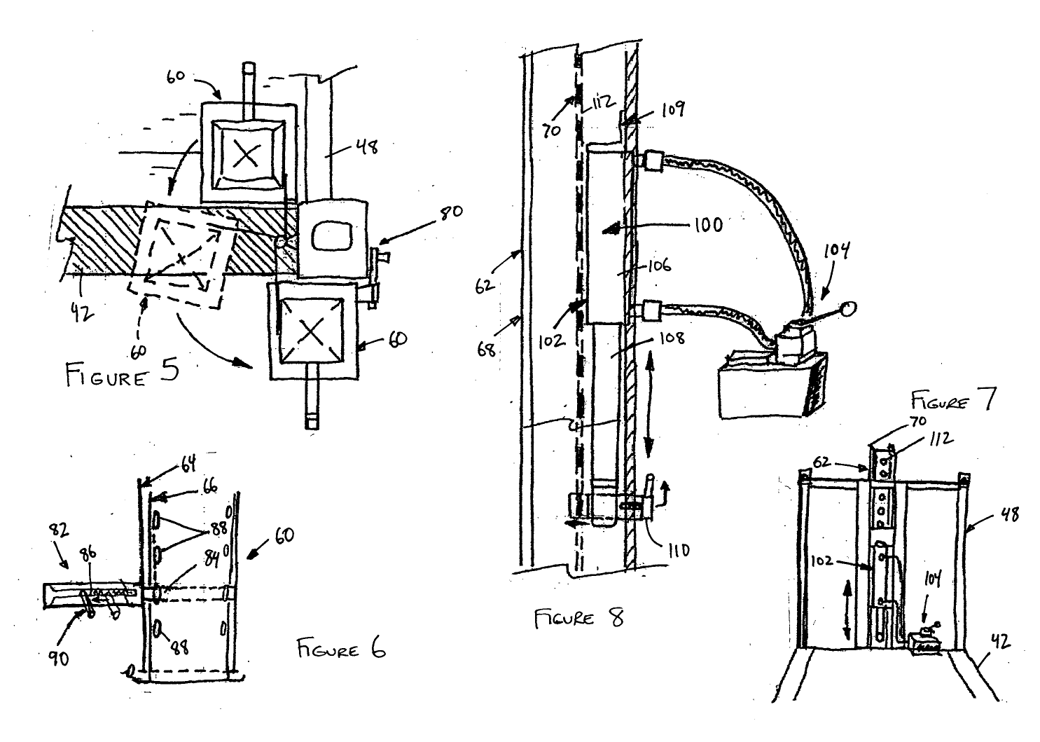

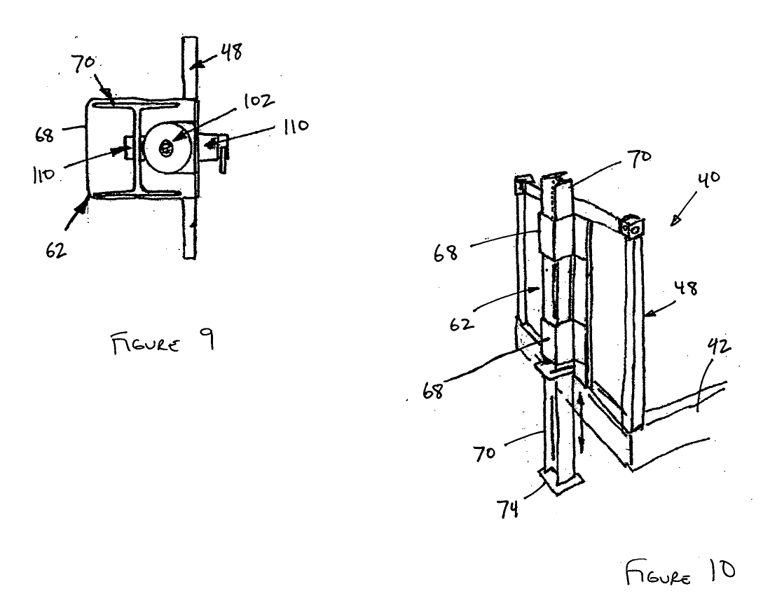

FIGS. 4 and 5 illustrate one corner of a rearward end 48 of the filter assembly 40. In FIG. 4, the passive deployment leg 60 is illustrated in a stowed position. Preferably, a pair of hinges 78 couple the deployment leg 60 to the rearward end 48. Thus, the hinges 78 permit the deployment leg 60 to be rotated from the stowed position to the deployed position, as illustrated in FIG. 5. If desired, a latch 80 may be provided to secure the deployment leg 60 in the deployed position. Although not shown, a similar latch 80 may be provided to secure the deployment leg 60 in the stowed position. Furthermore, it is not necessary for the legs 60 to be rotatably coupled to the filter assembly 40. In some applications it may be desirable for the legs 60 (or legs 62) to be removable.

With reference to FIG. 6, a retention mechanism 82 is configured to retain the deployment leg 60 in one of a plurality of available extended positions. In the illustrated arrangement, the retention mechanism 82 is a pin 84 biased by a spring 86 to engage cooperating holes 88 in each of the first leg portion 64 (or outer leg) and the second leg portion 66 (or inner leg). A handle 90 preferably is provided to permit the pin 84 to be manually retracted against the force of the biasing spring 86 or allowed to be advanced into cooperating pairs of the holes 88 of the outer leg 64 and the inner leg 66. Thus, the passive deployment leg 60 may be secured in a desired extended position between a fully retracted and a fully extended position.

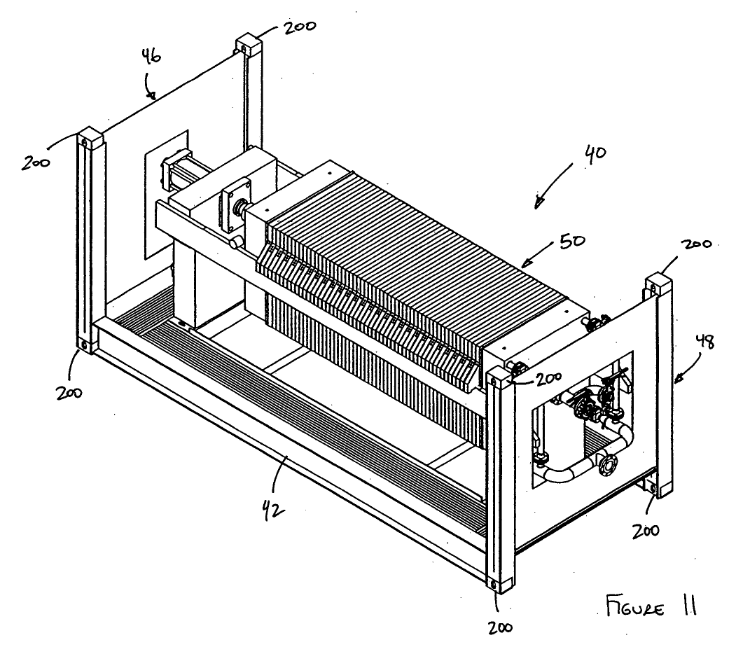

FIGS. 7-10 illustrate a preferred embodiment of an active deployment leg 62 employed on the rearward end 48 of the filter assembly 40. In the illustrated arrangement, the first leg portion 68 or outer leg is a tubular member that preferably is generally rectangular in cross-sectional shape. As illustrated in FIG. 10, the outer leg 68 may be interrupted along its length (e.g., the outer leg 68 is discontinuous or formed from multiple pieces). The second leg portion or inner leg 70 preferably is in the form of an I-beam, which is configured to telescopically engage with the outer leg 68.

The outer leg 68 and inner leg 70 preferably are interconnected through a force generator 100. The force generator 100 is configured to produce a force tending to extend the inner leg 70 relative to the outer leg 68 (and, thus, the rearward end 48 and platform 42). In the illustrated arrangement, the force generator is a hydraulic cylinder 102 configured to be extendable and retractable by a hydraulic pump 104. However, in other embodiments, the cylinder 102 may be only extendable by the hydraulic pump 104 and may include a biasing arrangement, such as a spring, for example, configured to retract the cylinder 102. Such a cylinder 102 is generally less expensive to employ.

The hydraulic cylinder 102 preferably includes a first portion 106 telescopically engaged with a second portion 108. The first portion 106 is secured to the rearward end 48 or outer leg 68 (via connector 109). The second portion 108 is securable to the inner leg 70 by a latch 110. The latch 110 is configured to selectively engage with one of a plurality of holes 112 defined by the inner leg 70. Thus, extension of the hydraulic cylinder 102 causes extension of the active deployment leg 62 when the latch 110 couples the hydraulic cylinder 102 to the inner leg 70. Similarly, retraction of the hydraulic cylinder 102 causes retraction of the active deployment leg 62.

The active deployment leg 62 could also include an additional latch assembly (similar to the latch 110) which would permit the active deployment leg 62 to be retained in an extended position after the cylinder 102 is uncoupled by the latch 110 and retracted. Such an arrangement would permit the active deployment leg 62 to be extended in a series of steps, or iterations. For example, the hydraulic cylinder 102 could be used to extend the active deployment leg 62 to a first height, at which point the secondary latch could be used to secure the active deployment leg 62 in the extended position. Subsequently, the hydraulic cylinder 102 could be released by the latch 110, retracted and reengaged to the inner leg 70 at a different point. The secondary latch could be then disengaged to permit further extension of the active deployment leg 62 via the cylinder 102. With such an arrangement, the hydraulic cylinder 102 could have a maximum stroke that is less than the height H (FIG. 3) at which the platform 42 is desired to be elevated above the support surface.

With the above-described arrangement, the filter assembly 40 may be raised above a surface to an elevated position, and maintained at the elevated position, utilizing a combination of the active deployment legs 62 and passive deployment legs 60. Thus, the filter assembly 40 may be loaded onto a transport trailer 56 (or other mode of transport) without extraneous material handling equipment, if desired. The filter assembly 40 can also be off loaded at the desired worksite without material handling equipment. Furthermore, the filter assembly 40 may be maintained at the elevated position to permit a waste removal container 72 to be positioned beneath the filter 50, which is not possible with the prior art integrated trailer and filter.

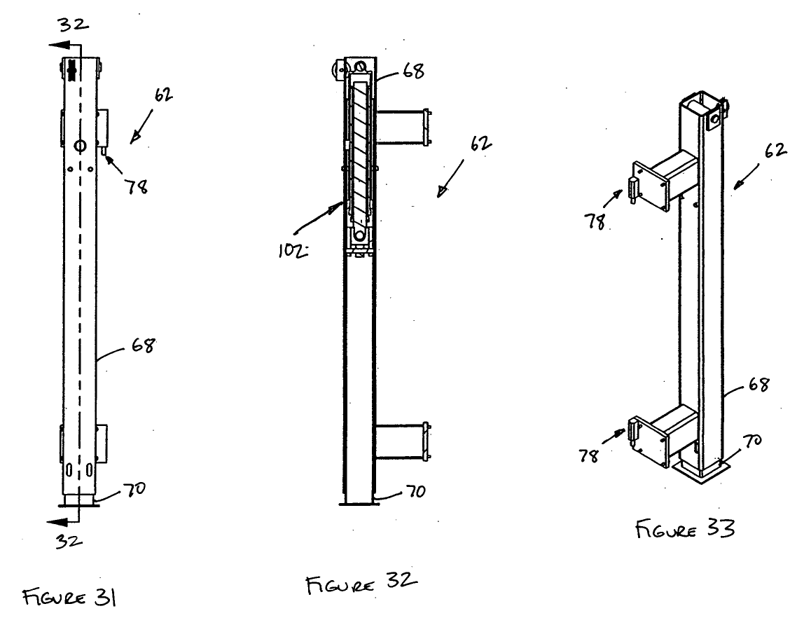

FIGS. 11-33 illustrate a modification of the filter assembly 40 of FIGS. 1-10. The filter assembly 40 of FIGS. 11-33, in many respects, is substantially similar to the filter assembly 40 of FIGS. 1-10. Accordingly, the same reference numbers are used to designate the same or similar components of the filter assembly 40 of FIGS. 11-33.

Advantageously, the filter assembly 40 of FIGS. 11-33 is configured to be transported by a variety of alternative modes of transportation. To facilitate such flexibility in the mode of transport, the filter assembly 40 preferably includes ISO mounts or lifting points 200 at each corner of the forward end 46 and rearward end 48. Thus, desirably, eight ISO lifting points 200 are provided in total and are arranged to form a generally rectangular shape. The ISO lifting points 200 preferably are configured in accordance with the ISO standards for such mounts, which are commonly employed in shipping containers. The lifting points 200 conform to a standard which permit the filter assembly 40 to be handled by material handling systems which are configured to lift and move standard shipping containers. Thus, the filter assembly 40 may be easily loaded onto semi trailers, trains, ships, or other modes of transport by existing material handling systems.

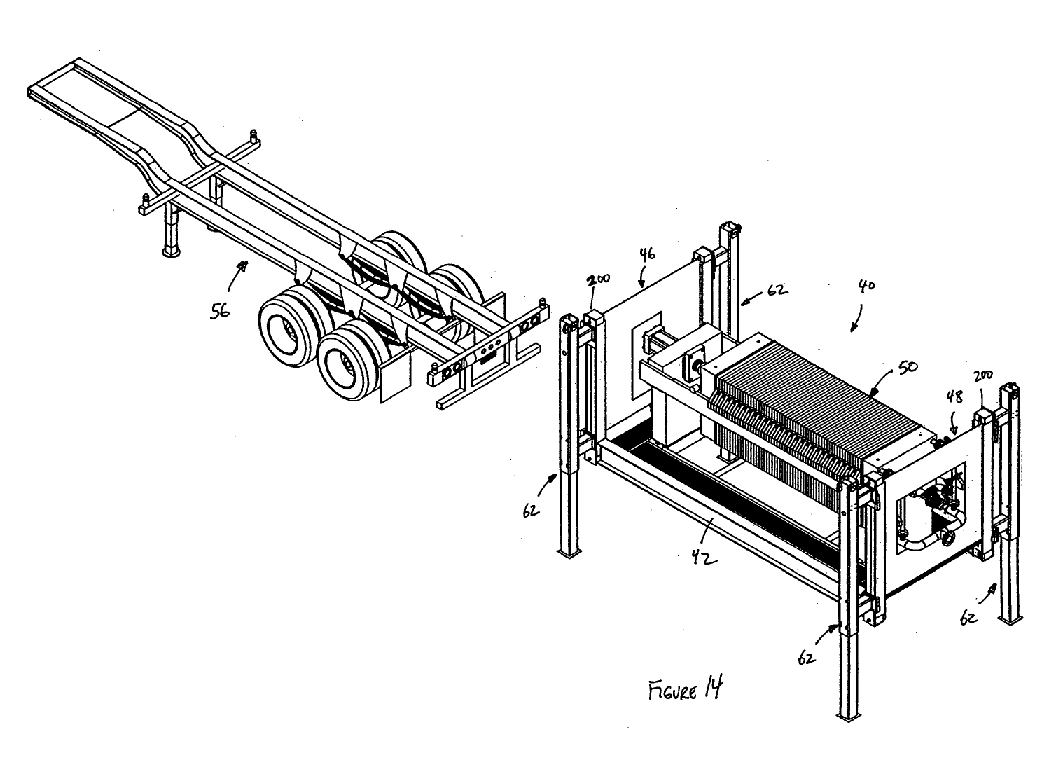

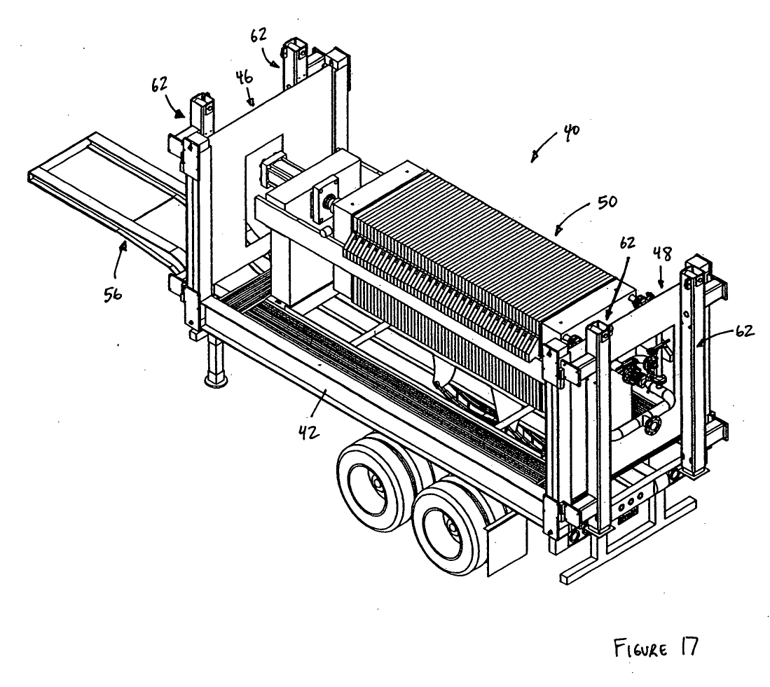

Another difference between the filter assembly 40 of FIGS. 11-33 is the absence of both passive deployment legs 60 and active deployment legs 62. Instead, the filter assembly 40 of FIGS. 11-33 preferably includes four active deployment legs 62 at each corner of the platform 42. In other words, the passive deployment legs 60 of the filter assembly 40 of FIGS. 1-10 have been replaced with active deployment legs 62, which may be similar to the active deployment legs 62 of the filter assembly 40 of FIGS. 1-10, and which are shown in greater detail in FIGS. 31-33. The deployment legs 62 preferably are movable between a deployed position (FIG. 12) and a stowed position (FIG. 17).

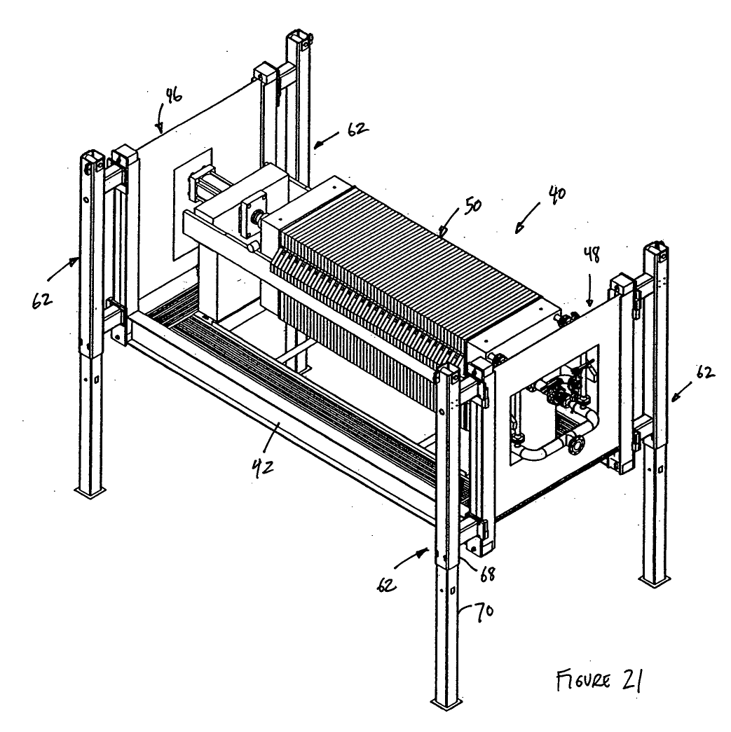

FIGS. 13-28 illustrate a preferred method for moving the filter assembly 40 from one location to a second location. FIGS. 13-22 illustrate perspective views of a preferred method and FIGS. 23a-28a and 23b-28b illustrate side and rear views, respectively, of the method of FIGS. 13-22.

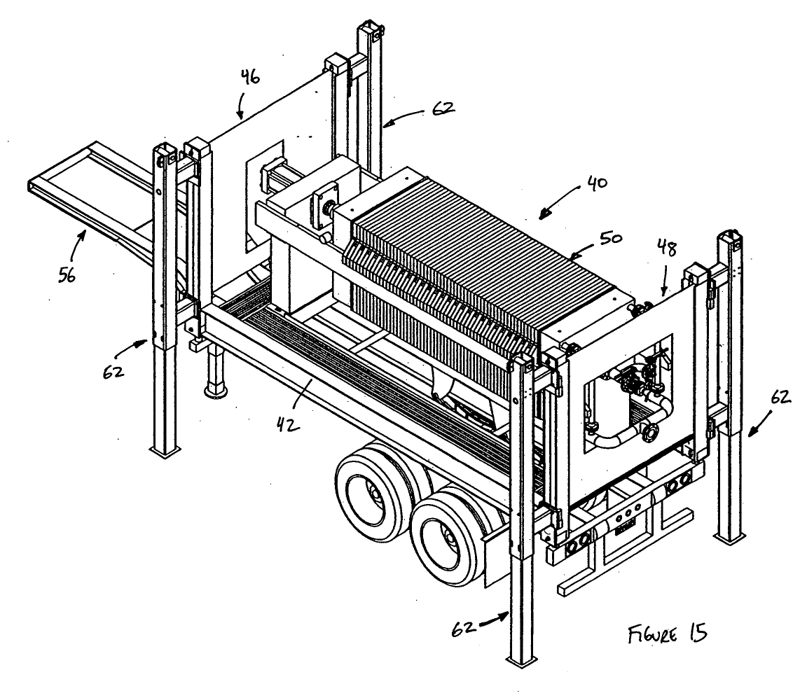

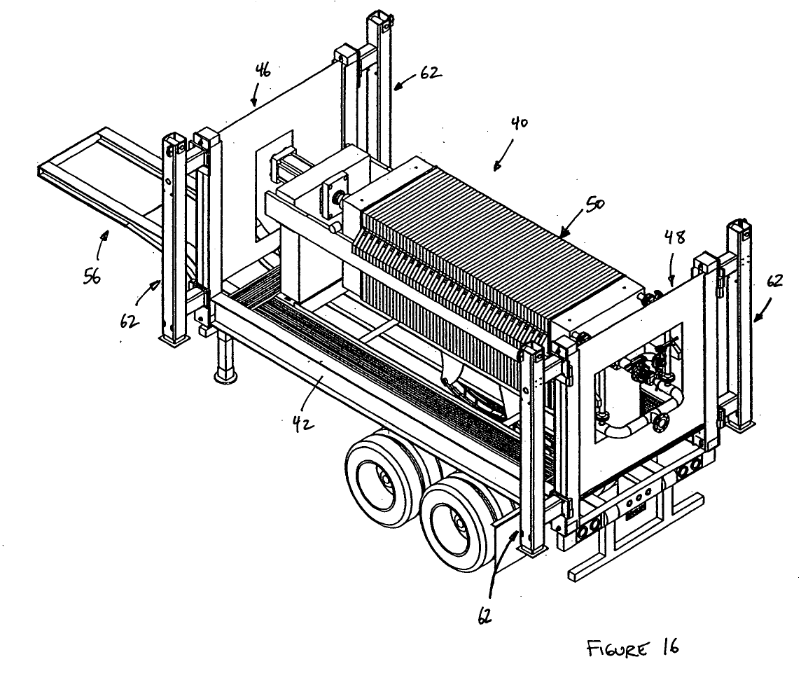

With reference to FIG. 13, the filter assembly 40 is illustrated in an elevated position. In FIG. 14, a transport trailer 56 is shown in position waiting to be moved underneath the elevated filter assembly 40. In FIG. 15, the transport trailer 56 has been moved beneath the filter assembly 40 and the deployment legs 62 used to lower the filter assembly 40 towards the transport trailer 56. As discussed above, alternative methods may be used to load the filter assembly 40 onto the transport trailer 56, such as utilizing material handling equipment configured to move the filter assembly 40 using the ISO lifting points 200. FIG. 16 illustrates the filter assembly 40 loaded onto the transport trailer 56 and the deployment legs 62 moved to a retracted position.

With reference to FIG. 17, the deployment legs 62 of the filter assembly 40 have been moved from a deployed position (FIG. 16) to a stowed position. In the stowed position, the deployment legs 62 preferably are positioned to reduce the overall width of the filter assembly 40 to allow for easier transport. Preferably, in the stowed position, the deployment legs 62 are within the perimeter of the platform 42.

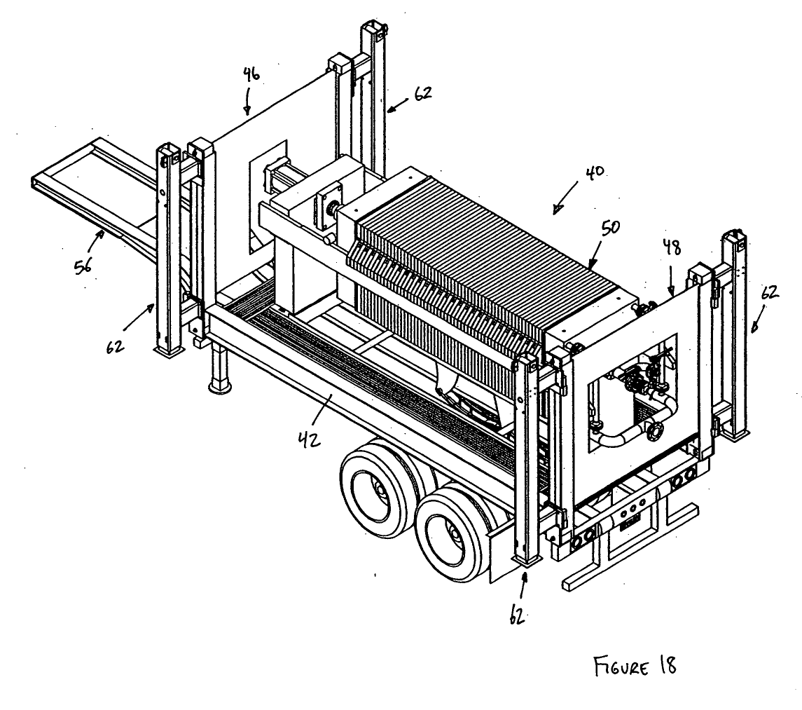

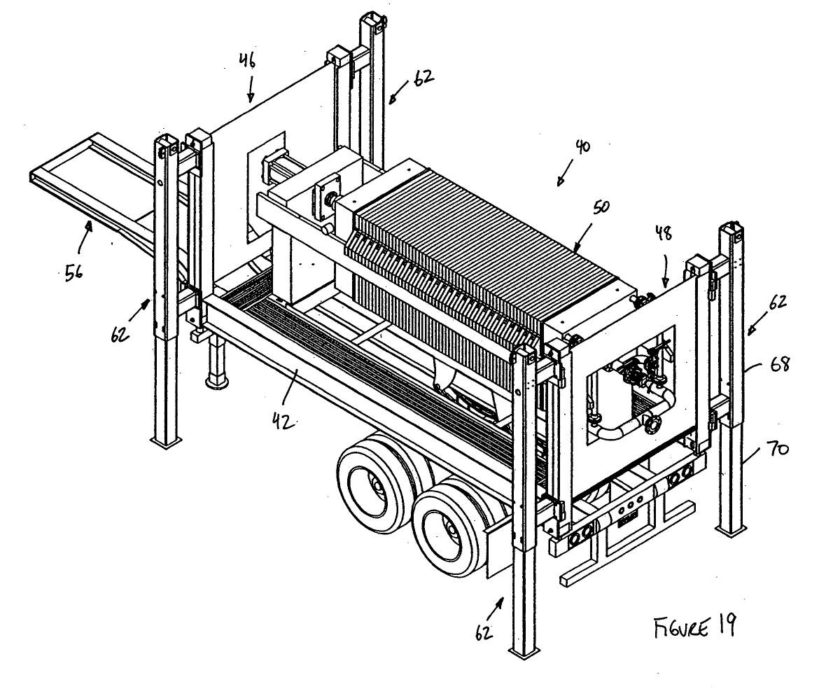

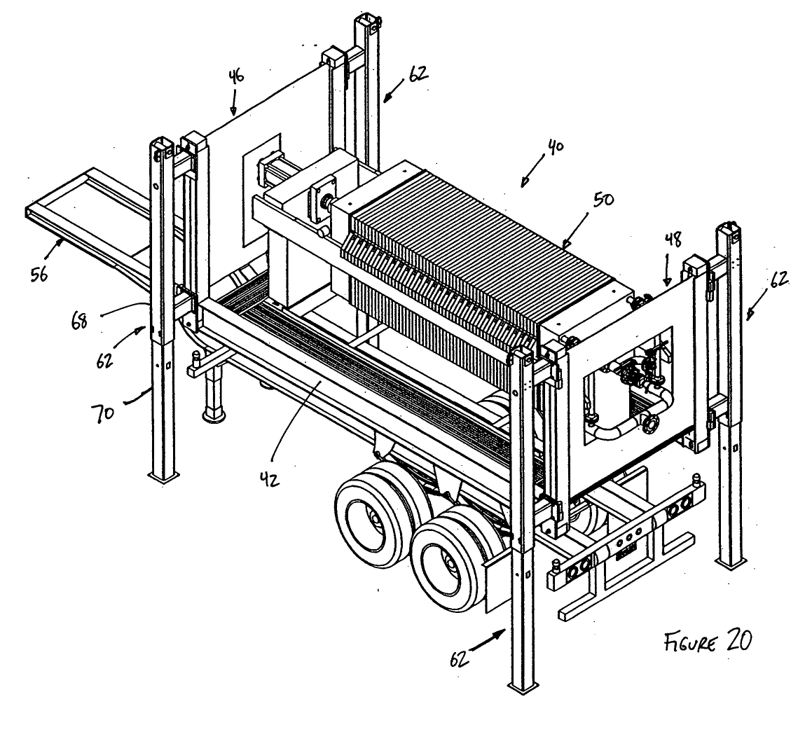

With reference to FIG. 18, the filter assembly 40 has been moved to a desired location via the transport trailer 56 and the deployment legs 62 have been moved to a deployed position. With reference to FIG. 19, the deployment legs are moved to an extended position to raise the filter assembly 40 off of the transport trailer 56. With reference to FIG. 20, the deployment legs 62 have been utilized to lift the filter assembly 40 off of the transport trailer 56, such that the transport trailer may be removed from beneath the filter assembly 40, as illustrated in FIG. 21. It is noted that the filter assembly 40 may be raised to a first elevated position to permit the transport trailer 56 to be removed and subsequently raised to a second elevated position higher than the first elevated position, or alternatively lowered to a second position that is lower than the first elevated position, once the transport trailer 56 has been removed, as discussed above. Such a method permits the transport trailer 56 to be removed quickly so that it can be utilized for an additional job. The desired elevated position of the filter assembly 40 may be determined subsequent to the removal of the transport trailer 56 and the filter assembly 40 may then be moved to the desired elevated position. Furthermore, the second position may be a fully lowered or substantially fully lowered position. In FIG. 22, a waste container 72 has been positioned beneath the filter assembly 40.

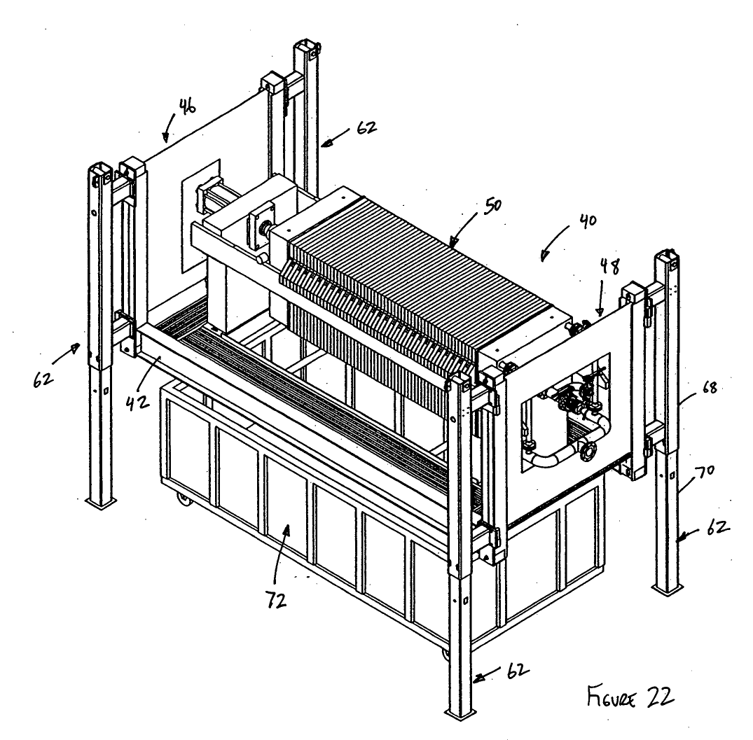

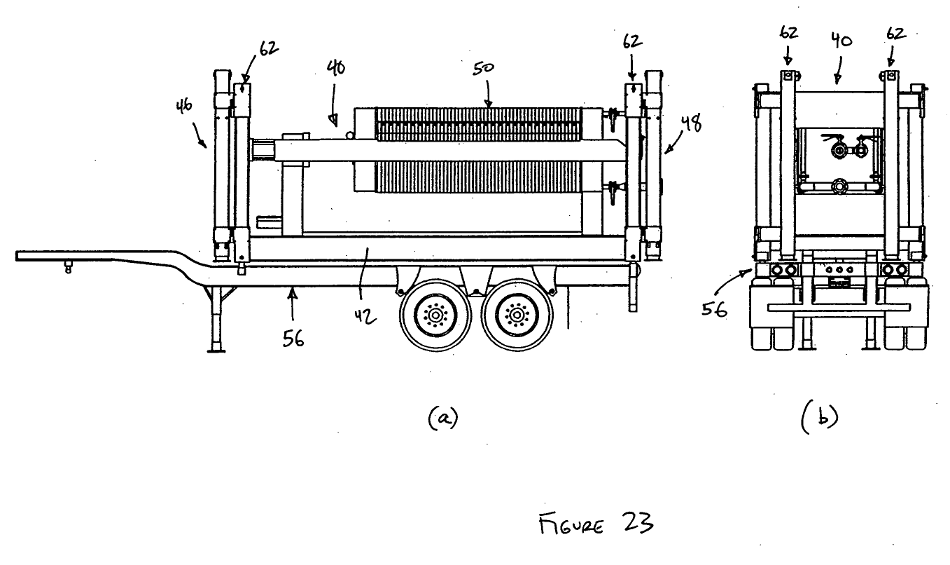

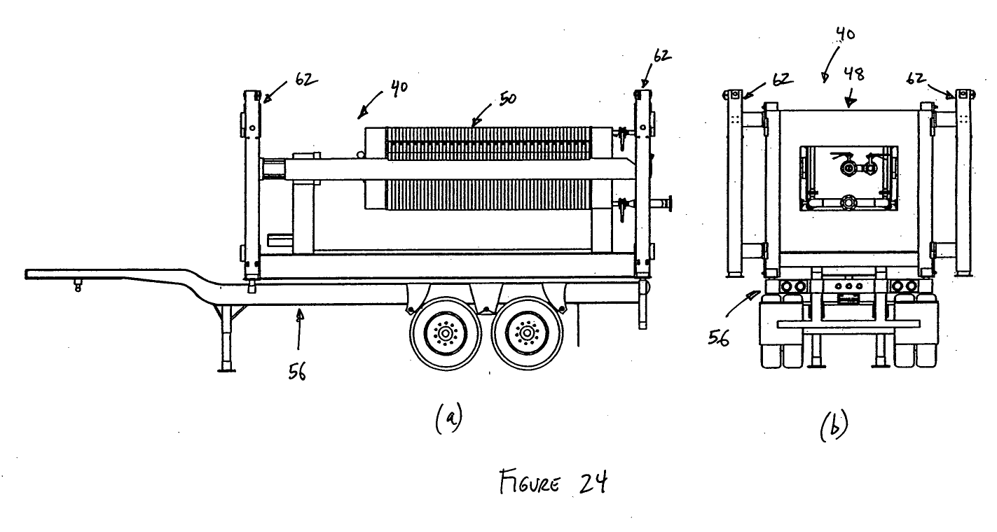

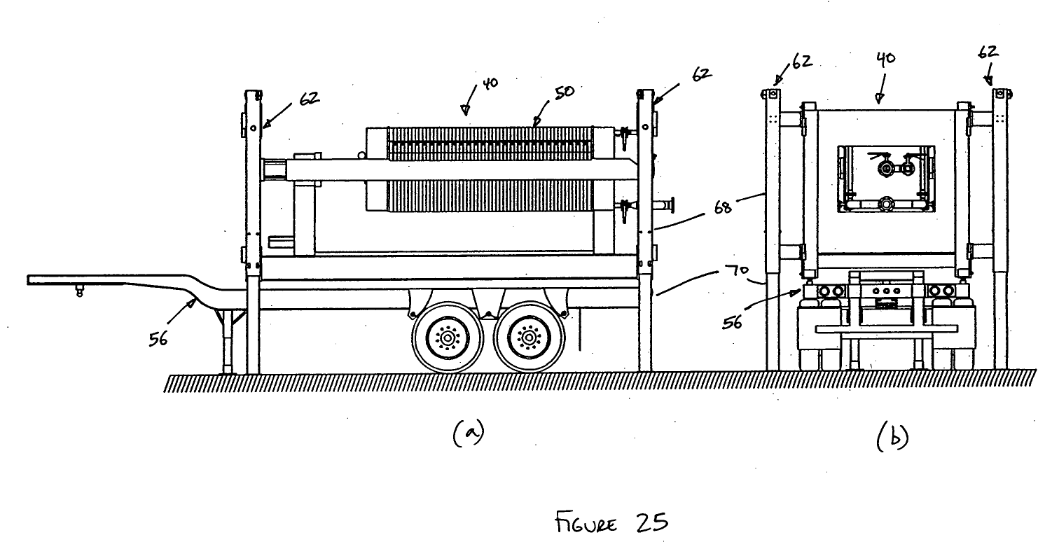

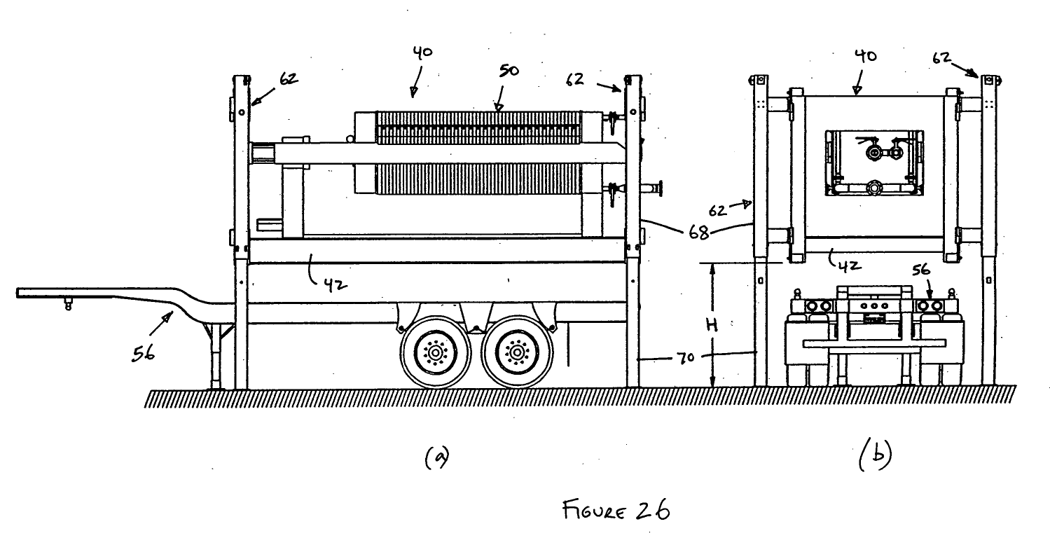

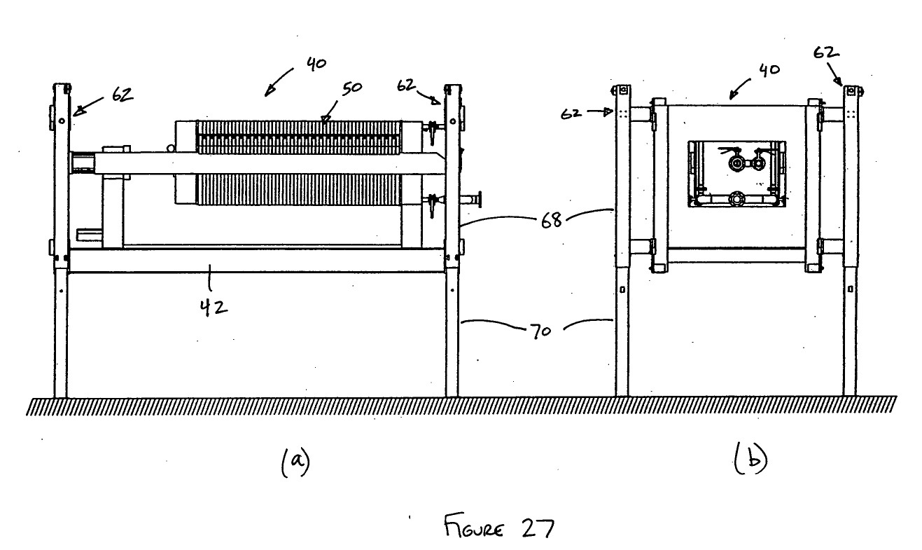

As discussed above, FIGS. 23-28 generally correspond with the method illustrated in FIGS. 13-22. However, FIGS. 23a-28a illustrate a side view of the filter assembly 40. FIGS. 23b-28b illustrate a rear view of the filter assembly 40 corresponding to the positions shown in FIGS. 23a-28a. FIGS. 23a and 23b illustrate the filter assembly loaded onto a transport trailer 56 with the deployment legs in a stowed position. FIGS. 24a and 24b illustrate the filter assembly moved to a desired location for use of the filter 40 with the deployment legs 62 moved to the deployed position. FIGS. 25a and 25b illustrate the filter assembly with the deployment legs 62 in an extended position to raise the filter assembly 40 off of the transport trailer 56. FIGS. 26a and 26b illustrate the filter assembly 40 raised to a desired height H, which preferably is sufficient to permit the transport trailer 56 to be removed from underneath the filter assembly 40. FIGS. 27a and 27b illustrate the filter assembly 40 with the transport trailer 56 removed. FIGS. 28a and 28b illustrate the filter assembly with a waste container 72 positioned underneath.

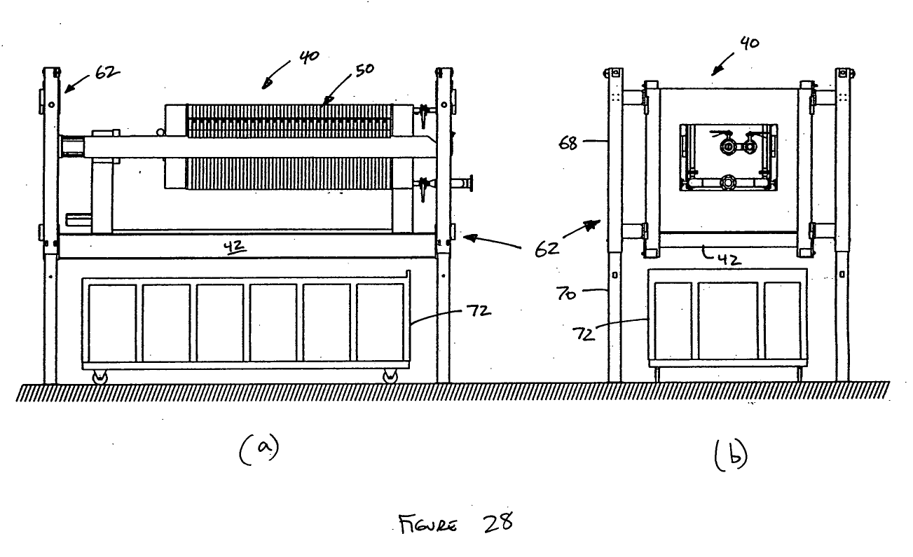

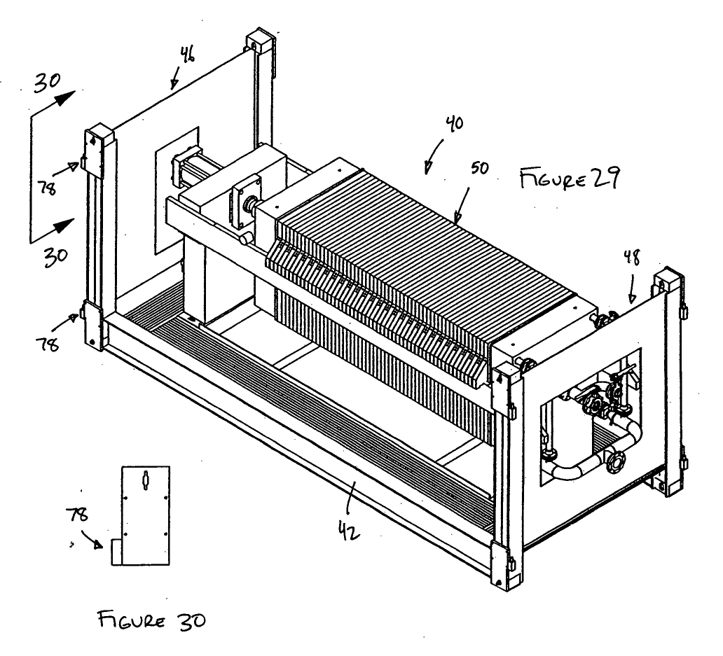

FIGS. 29 and 30 illustrate a portion of a desired coupler, or hinge 78, which permits the deployment legs 62 to be rotatably coupled to the filter assembly 40 and, specifically, to the forward end 46 and rearward end 48. Alternatively, as discussed above, the deployment legs 62 may be configured to be removably coupled to the respective first end 46 and second end 48 of the filter assembly 40 by any suitable mechanism, such as mechanical fasteners, for example but without limitation.

FIGS. 31-33 illustrate a preferred embodiment of the deployment leg 62. The deployment leg 62 includes a hydraulic cylinder 102 configured to extend the deployment leg 62. Preferably, the hydraulic cylinder 102 is configured to both extend and retract the deployment leg 62. The hydraulic cylinder 102 may be activated by a hydraulic pump 104, as described above. Each individual deployment leg 62 may include a dedicated hydraulic pump 104 or, alternatively, the hydraulic cylinders 102 of multiple deployment legs 62 may be controlled by a single hydraulic pump 104. Thus, in one arrangement, all of the deployment legs 62 are activated by a single hydraulic pump 104. Furthermore, other suitable systems or mechanisms may be employed to extend the deployment legs 62.

As discussed above, although the presently preferred embodiments described above involve a mobile filter assembly 40, it is also contemplated that other objects may utilize the disclosed system and methods to facilitate transport. In particular, objects that are desired to be maintained in an elevated position may benefit from an adaptation of the disclosed embodiments and methods. For example, it is contemplated that mobile homes or mobile offices (e.g., a contractor office) may utilize the present system and method for facilitating transport. For instance, such homes or offices may be configured with ISO lifting points 200 and/or deployments legs 60, 62 to facilitate loading, unloading, raising, lowering or maintaining the structure in an elevated position. Other applications include liquid, such as water, wastewater or other liquids (e.g., wine, beer), treatment or process equipment that has an advantage in being transported in a modular fashion. The system may also be used to store any number of items, from household goods to vehicles—either in an elevated or curbside level. This also includes service or contractor equipment—power plants, cellular stations, military equipment and temporary structures. In addition, other applications will be apparent to those of skill in the art in view of the disclosure herein.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In particular, while the present systems and methods has been described in the context of particularly preferred embodiments, the skilled artisan will appreciate, in view of the present disclosure, that certain advantages, features and aspects of the systems and methods may be realized in a variety of other applications, many of which have been noted above. Additionally, it is contemplated that various aspects and features of the invention described can be practiced separately, combined together, or substituted for one another, and that a variety of combination and subcombinations of the features and aspects can be made and still fall within the scope of the invention. Thus, it is intended that the scope of the present invention herein disclosed should not be limited by the particular disclosed embodiments described above, but should be determined only by a fair reading of the claims.

What is claimed is:

1. A mobile liquid treatment assembly, comprising:
a frame having a first end, a second end and a platform extending between said first end and said second end;
a liquid treatment device secured to said frame;
at least a first deployment leg assembly secured to said first end of said frame and at least a second deployment leg assembly secured to said second end of said frame, each of said deployment leg assemblies comprising a first leg and a second leg movable relative to one another, wherein said first leg is securable to said frame and said second leg includes a surface contacting foot at a lower end;
a force generator associated with each deployment leg assembly and configured to apply a force to said first leg and said second leg to move said second leg relative to said first leg such that said first and second deployment leg assemblies are capable of cooperating to raise said liquid treatment assembly to a desired height above a surface on which said liquid treatment assembly is supported.

2. The liquid treatment assembly of claim 1, wherein each of said first deployment leg assembly and said second deployment leg assembly is removable from said frame.

3. The liquid treatment assembly of claim 1, wherein each of said first deployment leg assembly and said second deployment leg assembly is rotatable relative to said frame from a stowed position to a deployed position.

4. The liquid treatment assembly of claim 3, additionally comprising a latch assembly associated with each of said first and second deployment leg assemblies and configured to secure said deployment leg assembly in said deployed position.

5. The liquid treatment assembly of claim 1, additionally comprising a first pair of support legs at said first end of said frame and a second pair of support legs at said second end of said frame, wherein said first pair and said second pair of support legs are configured to support said liquid treatment assembly at said desired height such that said first and second deployment leg assemblies may be retracted once said liquid treatment assembly has been raised to said desired height.

6. The liquid treatment assembly of claim 1, wherein said desired height is a height of at least six feet above said surface.

7. The liquid treatment assembly of claim 1, wherein said force generator comprises a hydraulic cylinder.

8. The liquid treatment assembly of claim 7, wherein a first end of said hydraulic cylinder is connected to said first leg and a second end of said hydraulic cylinder is selectively connectable to said second leg, each of said deployment legs additionally comprising a locking mechanism configured to selectively secure said first leg in a desired position relative to said second leg such that said second end of said hydraulic cylinder may be disconnected from said second leg and said hydraulic cylinder retracted after said liquid treatment assembly is raised to said desired height.

9. The liquid treatment assembly of claim 8, wherein a maximum stroke of said hydraulic cylinder is less than said desired height and wherein said second end of said hydraulic cylinder is securable to said second leg at a plurality of locations such that said hydraulic cylinder may be used to raise said liquid treatment assembly to said desired height in two or more iterative steps wherein said hydraulic cylinder is secured to a first one of said plurality of locations and is capable of moving said first and second legs to a first relative position defining a first combined height and then said hydraulic cylinder is retractable and securable to another one of said plurality of locations on said second leg and is capable of moving said first and second legs to a second relative position defining a second combined height greater than said first combined height.

10. The liquid treatment assembly of claim 7, wherein said hydraulic cylinder is a single action cylinder, additionally comprising a cylinder return mechanism configured to retract said hydraulic cylinder.

11. The liquid treatment assembly of claim 1, wherein said frame is configured to receive and support a removable ladder configured to permit a user to access said platform from said surface.

12. The liquid treatment assembly of claim 1, wherein said first and second ends of said frame comprise ISO standard lifting points to permit said liquid treatment assembly to be moved by ISO standard handling devices.

13. A method of deploying a mobile filter, comprising:
loading a filter onto a delivery vehicle at a first location, said filter supported by an integral frame, said frame including a platform surrounding at least a portion of said filter;
moving said vehicle including said filter to a desired second location remote from said first location;
utilizing at least a first deployment leg and second deployment leg to raise respective first and second ends of said filter to a first height relative to a surface on which said filter is desired to be supported such that said delivery vehicle may be removed from underneath said filter;
continuing to raise said filter with said first and second deployment legs to a second height greater than said first height;
maintaining said filter at said second height; and
positioning a waste receptacle below said filter configured to receive solid particulate cake discharged from said filter.

14. The method of claim 13, additionally comprising removing said delivery vehicle from underneath said filter after said filter is in said first position and prior to said raising of said filter to said second position.

15. The method of claim 13, additionally comprising rotating said first and second deployment legs from a stowed position to a deployed position relative to said frame prior to said raising of said filter to said first height.

16. The method of claim 13, wherein said maintaining of said filter at said second height is accomplished by utilizing a first pair of support legs at said first end of said filter and a second pair of support legs at said second end of said filter.

17. The method of claim 16, additionally comprising retracting said first and second deployment legs after said utilizing of said support legs to maintain said filter at said second height.

18. The method of claim 13, wherein said raising of said filter to said second height comprises raising said filter to a height of at least six feet relative to said surface.

19. The method of claim 13, wherein said utilizing said deployment legs to raise said filter comprises applying a force generated from a hydraulic force cylinder to relatively move a first portion and a second portion of each of said deployment legs.

20. The method of claim 13, additionally comprising securing a ladder to said frame to permit a user to access said platform.

21. A mobile filter assembly, comprising:
a frame having a first end, a second end and a platform extending between a lower portion of said first end and a lower portion of said second end, each of said first end and said second end having four corners cooperating to define a rectangular shape;
a filter secured to said frame, said filter configured to separate a solid component from a liquid component of a solid-liquid mixture; and
a lifting point located at each of said corners of said first and second ends, wherein said lifting points are sized, shaped and located to correspond with an ISO standard for container mounts.

22. A method of deploying an object to a remote location, comprising:
loading said object onto a delivery vehicle at a first location;
moving said delivery vehicle including said object to a desired second location remote from said first location;
applying a force to first and second movable portions of each of at least a first deployment leg and second deployment leg to raise respective first and second ends of said object to a first height relative to a surface on which said object is desired to be supported such that said delivery vehicle may be removed from underneath said object;
continuing to raise said object with said first and second deployment legs to a second height greater than said first height;
removing said force from said first and second portions of said deployment legs; and
maintaining said object at said second height.
